(19) United States
(12) Patent Application Publication
(10) Pub. No.: US 2023/0406149 A1
(43) Pub. Date: Dec. 21, 2023

(54) ELECTRIC VEHICLE REPLACEABLE BATTERY SYSTEM

(71) Applicant: Alton E. Ofczarzak, II, College Station, TX (US)

(72) Inventor: Alton E. Ofczarzak, II, College Station, TX (US)

(21) Appl. No.: 17/845,941

(22) Filed: Jun. 21, 2022

(51) Int. Cl. B60L 53/80; B60L 53/30; H02J 7/00; H02J 7/35

(52) U.S. Cl. CPC B60L 53/80; B60L 53/30; H02J 7/0013; H02J 7/00032; H02J 7/35; H02J 7/0045

(57) ABSTRACT

A replaceable battery system is presented. The replaceable battery system, provides for batteries in electric vehicles the ability to be exchanged via an automated hard casted vending station machine to effectively increase the range of the equipped electric vehicle. The system provides for a hard casted vending station machine, that is the approximate size of a large gasoline dispenser and is preferably a hard casted structure. The hard casted vending station machine is provided with battery charging equipment, multiple battery compartments, and a top cap.

### FIELD OF THE INVENTION

This invention relates to electric car batteries. More particularly, it relates to exchange of batteries systems in electric vehicles.

### BACKGROUND

An electric vehicle battery (EVB, also known as a traction battery) is a battery used to power the electric motors of a battery electric vehicle (BEV) or hybrid electric vehicle (HEV). These batteries are usually rechargeable (secondary) batteries, and are typically lithium-ion batteries. These batteries are specifically designed for a high ampere-hour (or kilowatt-hour) capacity.

Electric vehicle batteries differ from starting, lighting, and ignition (SLI) batteries as they are designed to give power over sustained periods of time and are deep-cycle batteries. Batteries for electric vehicles are characterized by their relatively high power-to-weight ratio, specific energy and energy density; smaller, lighter batteries are desirable because they reduce the weight of the vehicle and therefore improve its performance. Compared to liquid fuels, most current battery technologies have much lower specific energy, and this often impacts the maximum all-electric range of the vehicles.

The most common battery type in modern electric vehicles are lithium-ion and lithium polymer, because of their high energy density compared to their weight. Other types of rechargeable batteries used in electric vehicles include lead-acid (“flooded”, deep-cycle, and valve regulated lead acid), nickel-cadmium, nickel-metal hydride, and, less commonly, zinc-air, and sodium nickel chloride (“zebra”) batteries. The amount of electricity (i.e., electric charge) stored in batteries is measured in ampere hours or in coulombs, with the total energy often measured in kilowatt-hours.

Since the late 1990s, advances in lithium-ion battery technology have been driven by demands from portable electronics, laptop computers, mobile phones, and power tools. The BEV and HEV marketplace have reaped the benefits of these advances both in performance and energy density. Unlike earlier battery chemistries, notably nickel-cadmium, lithium-ion batteries can be discharged and recharged daily and at any state of charge.

Battery capacity for Non-plug-in hybrid cars have battery capacities between 0.65 kWh (2012 Honda Civic Hybrid) and 1.8 kWh (2001 Toyota Prius). For Plug-in hybrid cars battery capacities are between 4.4 kWh (2012 Toyota Prius Plug-in Hybrid) and 34 kWh (Polestar 1). All-electric cars have battery capacities between 6.0 kWh (2012 Renault Twizy) and 100 kWh (2012 Tesla Model S and 2015 Tesla Model X).

Driving range parity means that the electric vehicle has the same range as an average all-combustion vehicle (500 kilometers or 310 miles), with batteries of specific energy greater than 1 kWh/kg. Higher range means that the electric vehicles would run more kilometers without recharge. Currently, electric vehicle sales are lower than expected due range anxiety—even with the same range as an average all-combustion vehicle, buyers must be assured that there are widely available and compatible charging stations for their vehicles, which are currently not as common as gas stations.

Battery pack designs for Electric Vehicles (EVs) are complex and vary widely by manufacturer and specific application. However, they all incorporate a combination of several simple mechanical and electrical component systems which perform the basic required functions of the pack. The actual battery cells can have different chemistry, physical shapes, and sizes as preferred by various pack manufacturers. Battery packs will always incorporate many discrete cells connected in series and parallel to achieve the total voltage and current requirements of the pack. Battery packs for all electric drive EVs can contain several hundred individual cells. Each cell has a nominal voltage of 3-4 volts, depending on its chemical composition.

To assist in manufacturing and assembly, the large stack of cells is typically grouped into smaller stacks called modules. Several of these modules will be placed into a single pack. Within each module the cells are welded together to complete the electrical path for current flow. Modules can also incorporate cooling mechanisms, temperature monitors, and other devices. Modules must remain within a specific temperature range for optimal performance. In most cases, modules also allow for monitoring the voltage produced by each battery cell in the stack by using a Battery Management System (BMS).

The battery cell stack has a main fuse which limits the current of the pack under a short circuit condition. A “service plug” or “service disconnect” can be removed to split the battery stack into two electrically isolated halves. With the service plug removed, the exposed main terminals of the battery present no high potential electrical danger to service technicians.

The battery pack also contains relays, or contactors, which control the distribution of the battery pack's electrical power to the output terminals. In most cases there will be a minimum of two main relays which connect the battery cell stack to the main positive and negative output terminals of the pack, which then supply high current to the electrical drive motor. Some pack designs will include alternate current paths for pre-charging the drive system through a pre-charge resistor or for powering an auxiliary bus which will also have their own associated control relays. For safety reasons these relays are all normally open.

The battery pack also contains a variety of temperature, voltage, and current sensors. Collection of data from the pack sensors and activation of the pack relays are accomplished by the pack's Battery Monitoring Unit (BMU) or Battery Management System (BMS). The BMS is also responsible for communications with the vehicle outside the battery pack.

Batteries in BEVs must be periodically recharged. BEVs most commonly charge from the power grid (at home or using a street or shop recharging point), which is in turn generated from a variety of domestic resources, such as coal, hydroelectricity, nuclear, natural gas, and others. Home or grid power, such as photovoltaic solar cell panels, wind, or micro hydro may also be used and are promoted because of concerns regarding global warming. With suitable power supplies, good battery lifespan is usually achieved at charging rates not exceeding half of the capacity of the battery per hour (“0.5C”), thereby taking two or more hours for a full charge, but faster charging is available even for large capacity batteries.

Charging time at home is limited by the capacity of the household electrical outlet, unless specialized electrical wiring work is done. Recharging time varies among manufacturers. Electric cars like Tesla Model S, Renault Zoe, BMW i3, etc., can recharge their batteries to 80 percent at quick charging stations within 30 minutes. For example, a Tesla Model 3 Long Range charging on a 250 kW Tesla Version 3 Supercharger went from 2% state of charge with 6 miles (9.7 km) of range to 80% state of charge with 240 miles (390 km) of range in 27 minutes, which equates to 520 miles (840 km) per hour.

Recharging spots are increasing in number as popularity among electric vehicles continues to grow. As of April 2020, there are 93,439 locations and 178,381 EV charging stations worldwide. Though there are a lot of charging stations worldwide, and the number is only growing, an issue with this is that an EV driver may find themselves at a remote charging station with another vehicle plugged in to the only charger or they may find another vehicle parked in the only EV spot. Currently, no laws prohibit unplugging another person's vehicle, it is simply ruled by etiquette.

The range of a BEV depends on the number and type of batteries used. The weight and type of vehicle as well as terrain, weather, and the performance of the driver also have an impact, just as they do on the mileage of traditional vehicles. Electric vehicle conversion performance depends on a number of factors including the battery chemistry: Lead-acid batteries are the most available and inexpensive. Such conversions generally have a range of 30-80 km (19-50 mi). Production EVs with lead-acid batteries are capable of up to 130 km (81 mi) per charge. NiM11 batteries have higher specific energy than lead-acid; prototype EVs deliver up to 200 km (120 mi) of range. New lithium-ion battery-equipped EVs provide 320-480 km (200-300 mi) of range per charge. Lithium is also less expensive than nickel. Nickel-zinc battery are cheaper and lighter than Nickel-cadmium batteries. They are also cheaper than (but not as light as) lithium-ion batteries.

The internal resistance of some batteries may be significantly increased at low temperature which can cause noticeable reduction in the range of the vehicle and on the lifetime of the battery. Finding the economic balance of range versus performance, battery capacity versus weight, and battery type versus cost challenges every EV manufacturer.

With an AC system or advanced DC system, regenerative braking can extend range by up to 50% under extreme traffic conditions without complete stopping. Otherwise, the range is extended by about 10 to 15% in city driving, and only negligibly in highway driving, depending upon terrain. The performance and range constraints with the current electric car batteries in today's market limits long distance travel for electric vehicles. Also, the ability to find a charging station as well as the time required to charge a battery are challenges in today's world.

Accordingly, and in light of the foregoing, it would be desirable to have an apparatus where fully charged electric vehicle batteries are stored and could be exchanged for a recharged battery with a quick and easy transaction initiated from an app on a cellular device. The desired contents and location of this apparatus would be viewable from the app and would consist of battery types from different manufactures.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which, where the present invention works with cars, trucks, boats, airplanes, water sports equipment, jet skies, motorcycles, etc.:

FIG. 1 is a perspective view of the replaceable battery system 10, according to the preferred embodiment of the present invention;

FIG. 2 is a pictorial view of the replaceable battery system 10, shown in a utilized state, according to the preferred embodiment of the present invention;

FIG. 3 is a sectional view of the replaceable battery system 10, as seen along a line I-I, as shown in FIG. 1, according to the preferred embodiment of the present invention;

FIG. 4 is a perspective view of a battery 130 as used with the replaceable battery system 10, according to the preferred embodiment of the present invention;

FIG. 5 is a perspective view of the battery tray 180 as used with the battery charging equipment 20, according to the preferred embodiment of the present invention; and,

FIG. 6 is a perspective view of the batteries 130, shown in an installed state in the cargo space 210 of an electric vehicle 110, as used with the replaceable battery system 10, according to the preferred embodiment of the present invention.

### DESCRIPTIVE KEY

10 replaceable battery system
15 hard casted vending station machine
20 battery charging equipment
25 battery compartment
30 top cap
35 lighted logo area
40 front side
45 credit/debit card reader
50 control panel
55 charging cable
60 underground electric power feed
65 global positioning satellite (GPS) array
70 first radio frequency (RF) signal
75 second radio frequency (RF) signal
80 cellular network
85 Internet
90 data communication center
95 user
100 mobile telephone
105 third radio frequency (RF) signal
110 electric vehicle
115 fourth radio frequency (RF) signal
120 roadway
125 access door
130 battery
135 illumination light
140 carrying handle
145 output connector
150 power plug
155 power cord
160 retaining slot
165 bottom surface
170 semi-tubular retaining slot
175a positive charging contact
175b negative charging contact
176 positive cable
177 negative cable
180 battery tray
185 bottom surface
190 side surface
195 tubular protrusion
196 positive terminal
197 negative terminal
200 holding tab
205 fastener
210 cargo space

### DESCRIPTION OF THE PREFERRED EMBODIMENTS

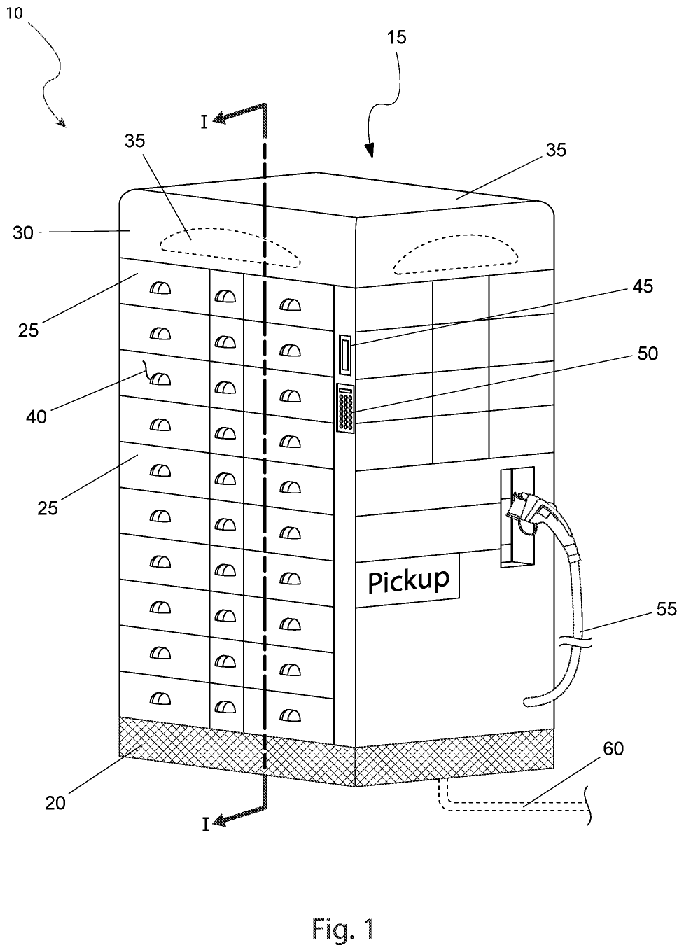

The best mode for carrying out the invention is presented in terms of its preferred embodiment, herein depicted within FIGS. 1 through 6. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 1. DETAILED DESCRIPTION OF THE FIGURES

Referring now to FIG. 1, a perspective view of the replaceable battery system 10, according to the preferred embodiment of the present invention is disclosed. The replaceable battery system (herein also described as the “system”) 10, provides for batteries 130 in electric vehicles 110 the ability to be exchanged via an automated hard casted vending station machine 15 to effectively increase the range of the equipped electric vehicle 110. The system 10 provides for a hard casted vending station machine 15, that is the approximate size of a large gasoline dispenser and is preferably a hard casted structure. The hard casted vending station machine 15 is provided with battery charging equipment 20, multiple battery compartments 25, and a top cap 30. The top cap 30 is provided with multiple lighted logo areas 35 to alert drivers to the presence of the hard casted vending station machine 15. The hard casted vending station machine 15 is preferably capable of holding at least forty (40) battery compartments 25 with at least twenty (20) battery compartments 25 per side. The rear side of the hard casted vending station machine 15 (not visible in this view) is identical to the front side 40. The front side 40 is provided with a credit/debit card reader 45 and a control panel 50 to allow for user 95 interface with the system 10, which will be described in greater detail herein below. A charging cable 55 is provided to allow users 95 to charge an electric vehicle 110 in a convendingal manner. The battery charging equipment 20 of the hard casted vending station machine 15 is provided power by an underground electric power feed 60 which is connected to a local utility. The underground electric power feed 60 may be backed up by dual feeds, a backup generator, a solar array or the like. The addition of any backup or alternate power source is not a limiting factor of the present invention.

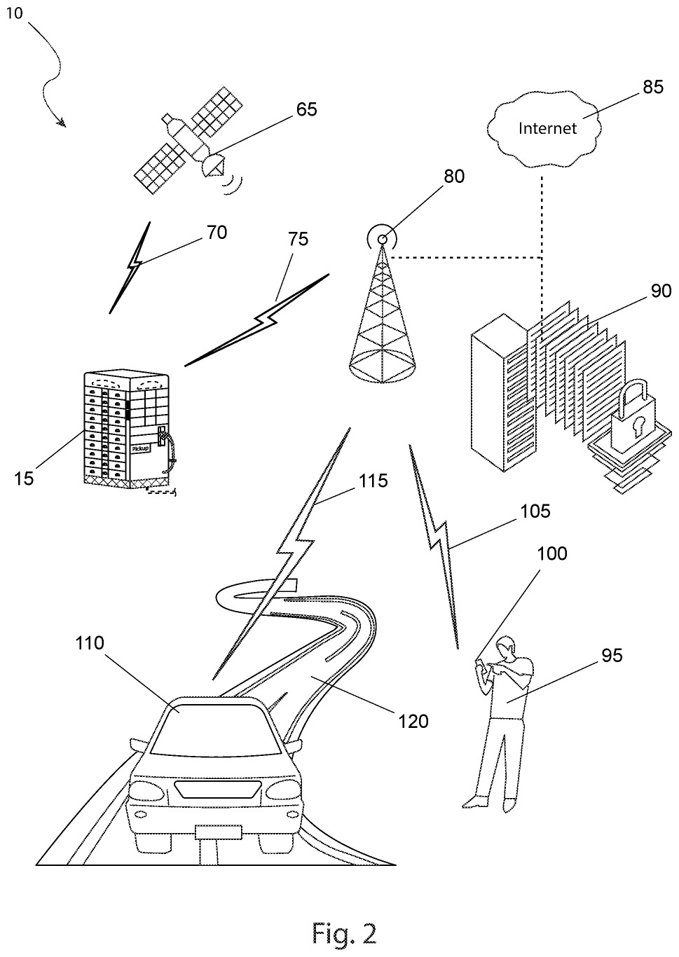

Referring next to FIG. 2, a pictorial view of the system 10, shown in a utilized state, according to the preferred embodiment of the present invention is depicted. The hard casted vending station machine 15 is in communication with the global positioning satellite (GPS) array 65 via a first radio frequency (RF) signal 70 to allow for the exact location of the hard casted vending station machine 15. A second radio frequency (RF) signal 75 then provides communication between the hard casted vending station machine 15 and a cellular network 80. The cellular network 80 is in communication with the Internet 85 and a data communication center 90 as provided in a typical manner. The data communication center 90 stores all information regarding the system 10 along with configuration and operational information on all hard casted vending station machines 15 located around the world. A local user 95 with a mobile telephone 100 is then in communication via a third radio frequency (RF) signal 105 to the cellular network 80, and ultimately the data communication center 90. An electric vehicle 110 is also in communication via a fourth radio frequency (RF) signal 115 to the cellular network 80 and ultimately the data communication center 90 as well. The fourth radio frequency (RF) signal 115 may be via a mobile telephone 100 carried by the user 95 of the electric vehicle 110 or via a dedicated cellular transceiver in the electric vehicle 110. The features of the communication network as described in FIG. 2 will permit the following communication and operation of the system 10:

The system 10 will reduce waiting time during battery 130 charging by replacement of the entire battery 130 rather than recharging the current battery 130. Additional information on said operation will be provided herein below.

The time necessary to remove and replace a battery 130 within the electric vehicle 110 is envisioned to be approximately five minutes (5 min.).

The credit/debit card reader 45 (as shown in FIG. 1) will debit and credit the financial accounts of the local user 95.

The data communication center 90 will track the location of the hard casted vending station machine 15 via the global positioning satellite (GPS) array 65 to prevent theft of the hard casted vending station machine 15 and/or batteries 130 used in the system 10.

The system 10 will be available for emergence and roadside assistance. Users 95 who are third-party individuals will be able to retrieve batteries 130 from the battery compartments 25 (as shown in FIG. 1) of the hard casted vending station machine 15 and bring them to the electric vehicle 110 at the side of a roadway 120.

The system 10 will have the ability via applications that run on the mobile telephone 100 to join clubs, offer coupons, and store rewards for usage.

When a local user 95 purchases a battery 130 from a hard casted vending station machine 15 for use in an electric vehicle 110, the data communication center 90 will keep track of the minutes used and track the systems mileage and place to place as a road map.

The system 10 will locate the electric vehicle 110 to warn of trouble in the road or the easiest way to complete the destination.

Microchips will be installed into the system 10 with high tech support systems.

The system 10 will be available for use during extreme weather events and for use in emergencies.

The system 10 will super charge at super speed and will provide the exchange time into minutes.

The system 10 would be available for use with electric vehicle 110. However, alternate vehicles, including but not limited to: bikes, motorcycles, sport boats, air planes, and the like are also envisioned.

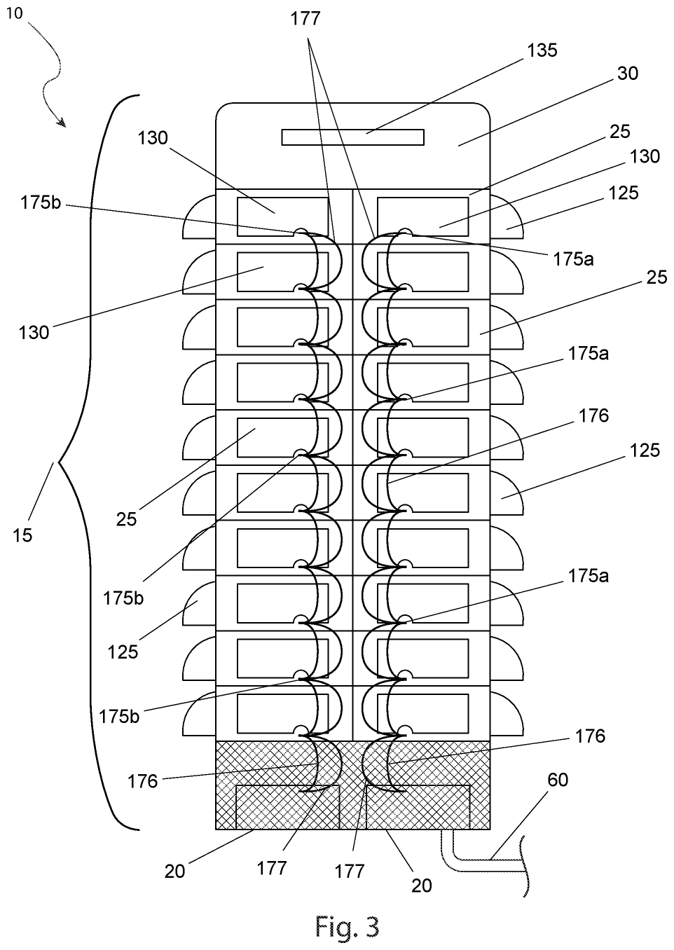

Referring now to FIG. 3, a sectional view of the system 10, as seen along a line I-I, as shown in FIG. 1, according to the preferred embodiment of the present invention is shown. Each battery compartment 25 in the hard casted vending station machine 15, is provided with an access door 125 allowing access to the interior of the battery compartment 25 for placement or removal of a batteries 130. The batteries 130 are inserted for charging and is removed when fully charged and when needed. Each battery 130 has a positive charging contact 175a that is in electrical communication with the battery charging equipment 20 via a positive cable 176 and a negative charging contact 175b that is in electrical communication with the battery charging equipment 20 via a negative cable 177. Further detail on the construction of a battery 130 will be provided herein below. An illumination light 135 is provided in the top cap 30 (as shown in FIG. 1) for backlighting illumination of the lighted logo areas 35 (as shown in FIG. 1).

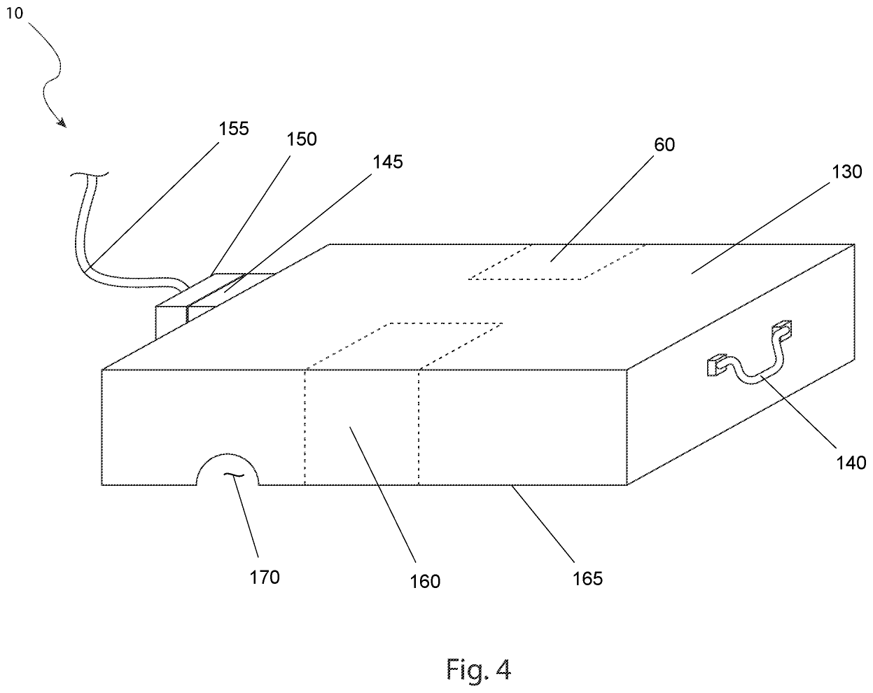

Referring next to FIG. 4, a perspective view of a battery 130 as used with the system 10, according to the preferred embodiment of the present invention is disclosed. The exact size of the battery 130 will vary per specific application and electric vehicle 110 (as shown in FIG. 2) upon which it is used. However, a typical size would be approximately three inches (3 in.) tall, fourteen inches (14 in.) long and ten inches (10 in.) deep. One (1) of the short ends of the battery 130 is provided with a carrying handle 140 to facilitate transport. The opposite end of the battery 130 is provided with an output connector 145. A power plug 150 and a power cord 155 is then inserted into the output connector 145 when the battery 130 is connected into an electric vehicle 110 (as shown in FIG. 2). The top and sides of the battery 130 is provided with a retaining slot 160 to facilitate securement inside of an electric vehicle 110, as will be described in greater detail herein below. A bottom surface 165 is provided with a semi-tubular retaining slot 170 that runs the entire bottom surface 165. In addition to aiding in securement of the battery 130, the semi-tubular retaining slot 170 provides for a positive charging contact 175a and a negative charging contact 175b (not shown due to illustrative limitations). The charging contacts 175a, 175b are used by the battery charging equipment 20 of the hard casted vending station machine 15 (as shown in FIGS. 1 and 2) while inside the battery compartments 25 (as shown in FIG. 3) for purposes of charging the battery 130.

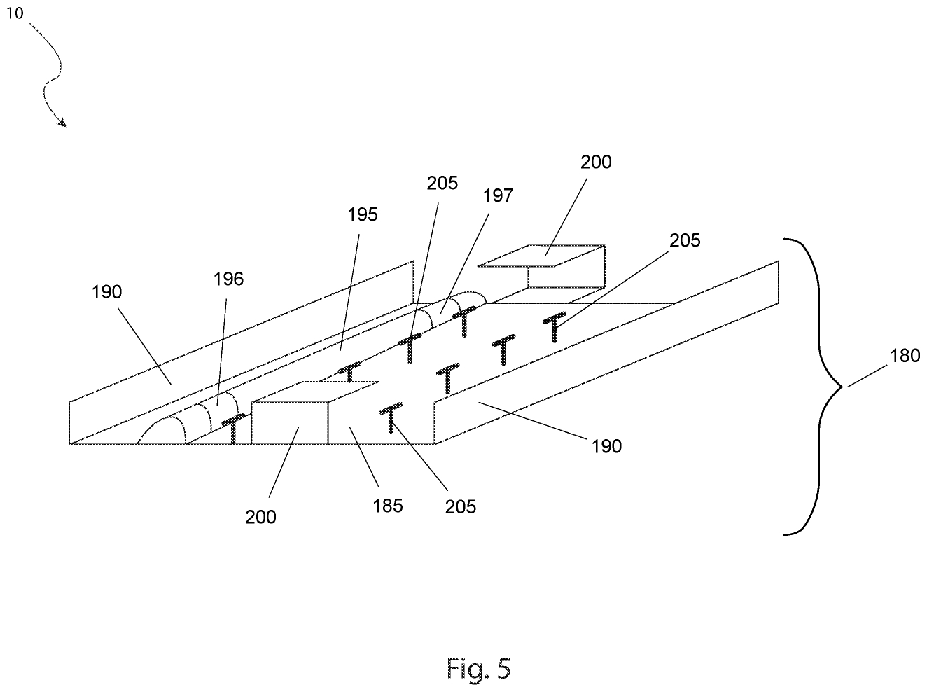

Referring now to FIG. 5, a perspective view of a battery tray 180 as used with the battery charging equipment 20, according to the preferred embodiment of the present invention is depicted. The battery tray 180 is provided with a bottom surface 185 and two (2) side surfaces 190 with the side surfaces 190 arranged in a parallel fashion. The bottom surface 185 is provided with a tubular protrusion 195 that accepts the semi-tubular retaining slot 170 (as shown in FIG. 4). The tubular protrusion 195 incorporates a positive terminal 196 capable of providing electrical communication between the battery charging equipment 20 and the positive charging contact 175a of the battery 130. The tubular protrusion 195 also incorporates a negative terminal 197 capable of providing electrical communication between the battery charging equipment 20 and the negative charging contact 175b of the battery 130. The battery tray 180 is also provided with two (2) holding tabs 200 that mechanically mate with the retaining slot 160 (as shown in FIG. 4) of the battery 130 (as shown in FIG. 4). The battery tray 180 is held in place in an electric vehicle 110 (as shown in FIG. 2) via multiple fasteners 205 such as screws, rivets, or the like.

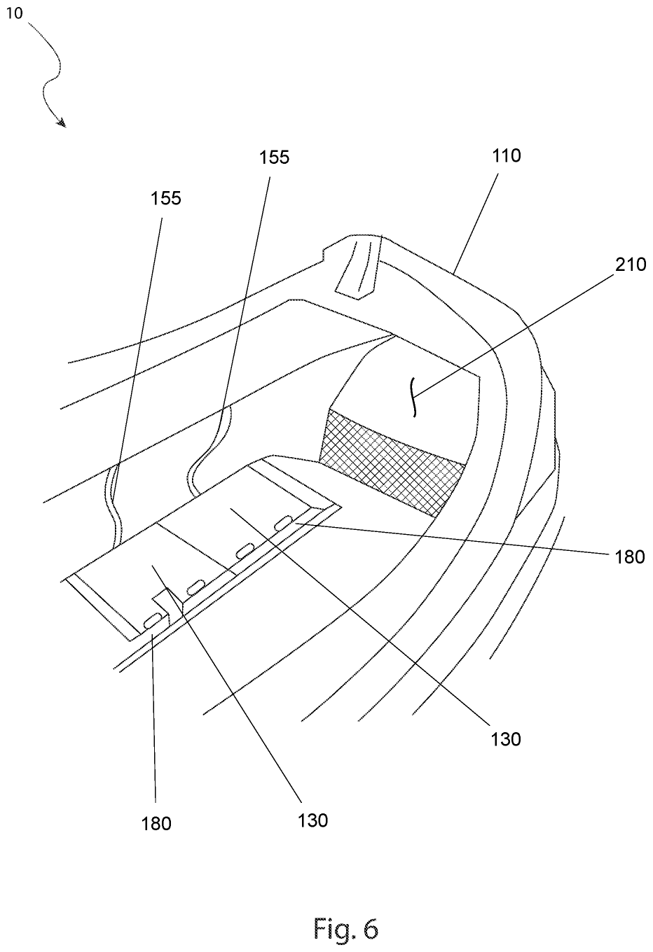

Referring to FIG. 6, a perspective view of batteries 130, shown in an installed state in the cargo space 210 of an electric vehicle 110, as used with the system 10, according to the preferred embodiment of the present invention is shown. The cargo space 210 is depicted as a rear trunk for purposes of illustration. However, other areas in the electric vehicle 110 (as shown in FIG. 2) such as any forward trunks, utility areas, below floor areas, and the like may also be used for the modular storage of multiple batteries 130. As such, the specific location of the cargo space 210 in the electric vehicle 110 is not intended to be a limiting factor of the present location. The battery tray 180 serves as a securing device to mechanically attach the batteries 130, while the power cords 155 serve to electrically attach the batteries 130 to the electric vehicle 110.

### 2. OPERATION OF THE PREFERRED EMBODIMENT

The preferred embodiment of the present invention can be utilized by the common user in a simple and effortless manner with little or no training. It is envisioned that the system 10 would be constructed in general accordance with FIG. 1 through FIG. 6. The user 95 would procure the electric vehicle 110 equipped with the batteries 130 as used with the system 10 from convendingal procurement channels such original equipment manufacturer (OEM) automotive suppliers and dealership chains.

During utilization of the system 10, operation is generally transparent when compared with convendingal electric vehicles 110. When the batteries 130 are depleted, they may be recharged in a convendingal manner, or by the charging cable 55 connected to a hard casted vending station machine 15. Should the user 95 require a more rapid charging time, the following process would be utilized: the local user 95 would find the location of the nearest hard casted vending station machine 15 using the electric vehicle 110 to connect to the data communication center 90; the data communication center 90 would then provide directions to direct the local user 95 (including the electric vehicle 110) to the GPS coordinates of the hard casted vending station machine 15; the local user 95 would then purchase one (1) or more fully charged batteries 130 using the credit/debit card reader 45 and the control panel 50; the one (1) or more fully charged batteries 130 would be inserted into the cargo space 210 and the battery tray 180, mechanically connected via the holding tabs 200 and the tubular protrusion 195, and electrically connected via the power plug 150 and the power cord 155; and each of the discharged one (1) or more batteries 130 would be placed in a battery compartment 25 for charging via the charging contacts 175a, 175b being in electrical communication with the battery charging equipment 20 via the terminals 196, 197 and cables 176, 177. At this point in time, the transaction is complete, and the local user 95 continues on their way. Future depletion of the one (1) or more batteries 130 would be handled in a repeating manner.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A replaceable battery system for exchanging battery systems for electric vehicles, the system comprising:
a hard casted vending station machine, the hard casted vending station machine comprising:
a battery charging equipment, the battery charging equipment having an electric power feed;
multiple battery compartments; and
a top cap.

2. The system according to claim 1, wherein the top cap having a logo area.

3. The system according to claim 2, wherein the logo area being lighted.

4. The system according to claim 1, wherein the hard casted vending station machine having at least forty of the battery compartments.

5. The system according to claim 1, wherein the hard casted vending station machine having at least twenty battery compartments on each of a plurality of sides of the hard casted vending station machine.

6. The system according to claim 1, wherein the hard casted vending station machine comprising:
a front side, the front side having a credit/debit card reader and a user control panel;
a charging cable, the charging cable for coupling a battery of a user with the hard casted vending station machine;
a rear side, the rear side having a credit/debit card reader and a user control panel.

7. The system according to claim 1, wherein the electric power feed being buried underground.

8. The system according to claim 7, wherein the electric power feed being coupled to a local utility.

9. The system according to claim 7, wherein the electric power feed having a backup power source.

10. The system according to claim 9, wherein the backup power source being a dual feed.

11. The system according to claim 9, wherein the backup power source being a solar array.

12. The system according to claim 1, wherein the hard casted vending station machine being electronically coupled to a global positioning satellite (GPS) array by a first radio frequency (RF) signal and a cellular network.

13. The system according to claim 12, wherein the cellular network being in communication with an Internet and a data communication system.

14. The system according to claim 13, wherein the data communication system configured to store all information regarding the system and any other such system.

15. The system according to claim 12, wherein the data communication system being configured to determine an issue with a battery system of the electric vehicle.

16. The system according to claim 13, wherein the system sending a message to the electric vehicle indicating adverse road conditions.

17. The system according to claim 1, wherein the vendor charging system receives a battery for charging.

18. The system according to claim 17, wherein the battery for charging is placed in one of the battery compartments for charging.

19. The system according to claim 18, wherein the battery being removed from the battery compartment upon completion of charging.

20. The system according to claim 1, wherein each of the battery compartments further comprise:
a battery tray, the battery tray having a bottom surface and two side surfaces, where each of the side surfaces are arranged in a parallel fashion.
